(19) United States
(12) Patent Application Publication
(10) Pub. No.: US 2013/0060718 A1
(43) Pub. Date: Mar. 7, 2013

(54) TOOLING DESIGN PRICE QUOTATION IN PRODUCT DATA MANAGEMENT SYSTEMS

(71) Applicant: Shengming Liu, Cypress, CA (US)

(72) Inventor: Shengming Liu, Cypress, CA (US)

(73) Assignee: SIEMENS PRODUCT LIFECYCLE MANAGEMENT SOFTWARE INC., Plano, TX (US)

(21) Appl. No.: 13/223,790

(22) Filed: Sep. 1, 2011

(51) Int. Cl. G06Q 30/02; G06Q 10/06

(52) U.S. Cl. 705/400

(57) ABSTRACT

Methods for product data management (PDM) and corresponding systems and computer-readable mediums. A method includes receiving a strip layout for a part and retrieving strip information corresponding to the strip layout. The method includes receiving a die base design for the part and receiving toolset information for the part. The method includes receiving pricing information corresponding to the toolset information, strip information, and die base design. The method includes producing a quotation output based on the pricing information, toolset information, strip information, and die base design.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data Improved systems are desirable.

### SUMMARY OF THE DISCLOSURE

Various disclosed embodiments include methods for product data management (PDM) and corresponding systems and computer-readable mediums. A method includes receiving a strip layout for a part and retrieving strip information corresponding to the strip layout. The method includes receiving a die base design for the part and receiving toolset information for the part. The method includes receiving pricing information corresponding to the toolset information, strip information, and die base design. The method includes producing a quotation output based on the pricing information, toolset information, strip information, and die base design.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2A depicts an example of a sheet metal part, and FIG. 2B depicts an example of a corresponding 3D strip layout;

FIG. 3 depicts a flowchart of a process in accordance with disclosed embodiments; and

FIG. 4 illustrates an example of a quotation output in accordance with disclosed embodiments.

### DETAILED DESCRIPTION

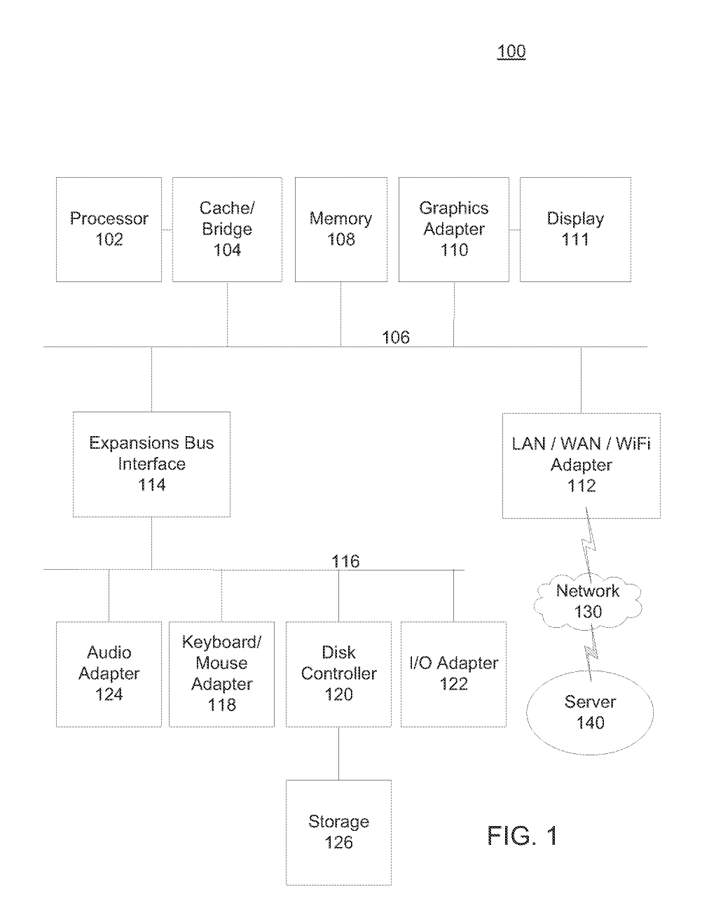

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In an era of fast development and production cycles, products are changed more frequently and in a more complex way than ever before. The tooling industry finds it extremely challenging to shorten delivery time. To address these issues, the tooling industry has been moving from two-dimensional (2D) design systems to three-dimensional (3D) design systems over the past decade.

There are many advantages in 3D design systems over 2D systems. Some software vendors also further develop specific solutions for the tooling industry based on generic 3D CAD systems that make tooling design much easier and faster than before.

One recurring problem is that of providing fast and accurate design cost quotations. Quick quotations happen every day in tooling shop. With the increasing competition in the tooling industry, the quotation needs to be accurate and fast. Slower quotations will lose the business opportunity, and inaccurate quotations can cause the tooling company to make less money or even worse, lose money, and can lead to the quoting company being beaten by their competitors due to incorrectly high price quotations.

Though the tooling industry has largely moved from 2D to 3D design and manufacturing, quotations for 3D design are still based on very skilled veteran's experience. Disclosed embodiments include systems and methods for quick quotations for 3D design.

Quick quotation processes as described herein are fast and accurate. In this context, “fast” means the quotation will be done before a full set of tools are complete because completion of a set of tool designs usually takes several weeks, and “accurate” means the quotation tool can predict the price, as a function of actual cost and profit, based on the unfinished design.

Disclosed embodiments are based on 3D conceptual design and a company's formulized standard and know-how. Various embodiments can produce tooling quotations quickly and accurately.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include processes for quick 3D strip layout and conceptual design to produce a quotation quickly and accurately. Various embodiments can use a standardized workflow to produce a quick quotation based on 3D accurate or rough strip layouts, and provide processes that can reuse information from existing strip layouts and conceptual tooling structure designs to get the necessary information for quotation.

Various embodiments can also reuse company standards and historical data/information stored in a formularized spreadsheet or other data storage of a PLM system. Various embodiments can provide functions with a user-friendly graphical user interface (GUI) to combine case-specific information and company-standard information for quotations.

Strip-layout design is an important step in the planning stage of sheet metal work on a progressive die. The 3D strip layout provides a “blueprint” for the efficient manufacture of a stamped sheet-metal part. The strip layout is a visual representation of the sequential operations performed on the sheet-metal strip to form the sheet-metal part, and can show the position and relationship of each workstation on the die. A strip layout is often created by “reverse-processing” the intended part to determine the strip layout required to produce that part.

Stamping is a process by which thin-walled metal parts can be formed from sheet metal by use of punches or dies driving by hydraulic or mechanical presses. A progressive die generally includes a series of stations that each perform sheet-metal operations on the strip, such as punching, bending, notching, etc. The strip layout represents the operations needed to form the part from the sheet-metal strip, and can be created and maintained by a PDM system as a CAD model corresponding to the part, and can be used to produce the quotations as described herein.

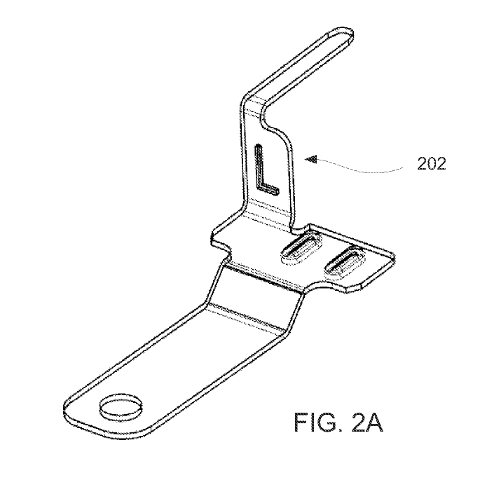

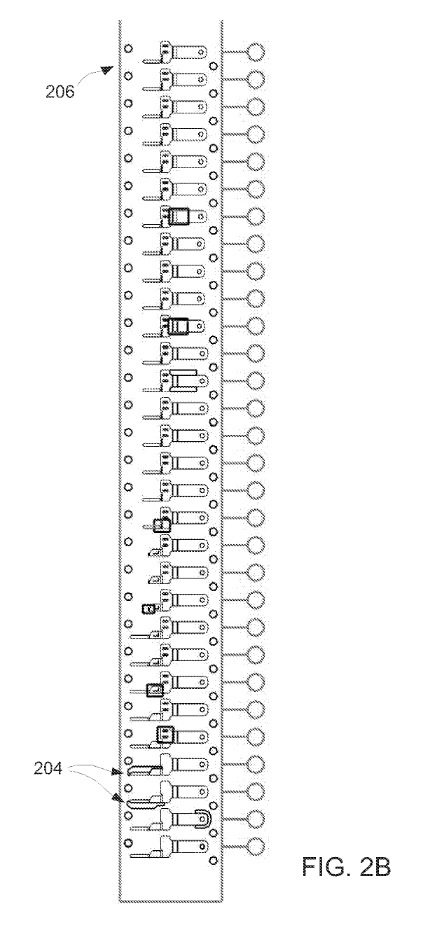

FIG. 2A depicts an example of a sheet metal part 202, and FIG. 2B depicts an example of a corresponding 3D strip layout. The example 3D strip layout in FIG. 2B shows multiple layouts 204, on sheet metal strip 206, used to produce a number of the example sheet metal parts 202 of FIG. 2A.

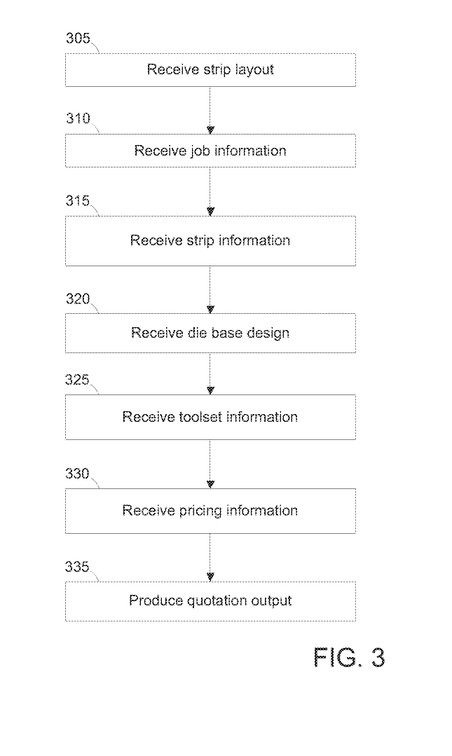

FIG. 3 depicts a flowchart of a process in accordance with disclosed embodiments. Such a process can be performed by a PDM system or other data processing system.

The system receives and stores a strip layout for a part for which a design price quotation is to be determined (step 305). “Receiving”, as used herein, can include loading from storage, receiving from another system or process, or receiving via an interaction with a user. In some cases, the system can receive the strip layout by performing a 3D strip layout design process via an interaction with a user, for example using the NX PROGRESSIVE DIE WIZARD software product by Siemens Product Lifecycle Management Software, Inc. The strip layout can be stored as a CAD model.

The system can optionally receive job information for the part (step 310). The job information can include such information as a quotation number, a data, a user ID, or a customer ID.

The system can automatically retrieve strip information corresponding to or from the strip layout (step 315). The strip information can include a number of rows, a blank size, a number of stations, a pitch distance, a strip width, a strip thickness, a strip material, an amount of sheet metal parts to be produced, or a complex factor. This strip information can be used to retrieve case-specific information for the quotation.

In some cases, after a user has roughly designed the strip layout above, some or all of the strip information will have been stored in the strip layout as part attributes. The system can easily retrieve this information for cost estimation. Alternatively, some or all of the strip information can be received from a user, including, in particular, the number of sheet metal parts to be produced and the complex factor.

The complex factor indicates the relative complexity of the part/tool. A “basic” complex factor, for example, can be 1.0, to represent the company-typical parts they are making. If the actor is less than 1.0, this can mean that the part is easier than regular parts daily making, and if the factor is larger than 1.0, this can mean that the part is harder or more complex than normal parts. Since a formularized company cost standard is based on the typical parts the company makes, the final cost estimation can use the complex factor as a scaling factor based on the complexity of the parts.

The system can receive a die base design (step 320). This can be performed, for example, by an interaction with a user, or the system can automatically generate the die base design from the strip layout. The die base design can include such information as the names of the plates for the die and other characteristics of the plates, such as material, dimensions, quantity, and whether each plate is heat treated. This step can also include receiving insert groups for the die base design, such as piercing inserts, bending inserts, forming inserts, burring inserts, or cam unit.

Based on the die base design, the system can determine the size of die base and the insert, groups. In some cases, a user can input, and the system can receive, die plate heights; the system can determine punch and die insert heights automatically according to the die plate heights. The system can also receive a user selection as to whether heat treating is needed or what material should be used.

In some cases, the system can receive a profile for die base, bending insert, forming insert, etc., using a product such as the NX SKETCHER by Siemens Product Lifecycle Management Software, Inc. Piercing inserts can be based on scraps which already exist in strip layout and can be handled automatically by the system.

The die base design can include the die structure, stations, and inserts and can be developed directly from the strip model, using preconfigured die bases, advanced die base design tools and standard inset groups. The system can maintain associativity with the part design through the entire die design process. The system can use a standard part library that can include supplier catalogs. Customizable die base libraries, standard part libraries, and insert group libraries can also be used.

The system can receive toolset information based on the strip layout and die base design (step 325).

The system receives pricing information corresponding to the toolset information, strip information, and die base design (step 330). The pricing information can be, for example, loaded from a database or other storage, and can include information relating to prices of materials, prices of blanks, processing cost, and otherwise.

The system produces a quotation output based on the pricing information, toolset information, strip layout, and die base design (step 335). This step can include storing the quotation output or displaying it to a user.

As part of this step, the system can combine case-specific data with company-standard data to work out a quotation in a formularized spreadsheet form or otherwise. The system can automatically output the case-specific data collected in previous steps into a standardized spreadsheet template to produce the quotation. The individual cost and total cost can be automatically calculated out through embedded formulas to be presented in the quotation.

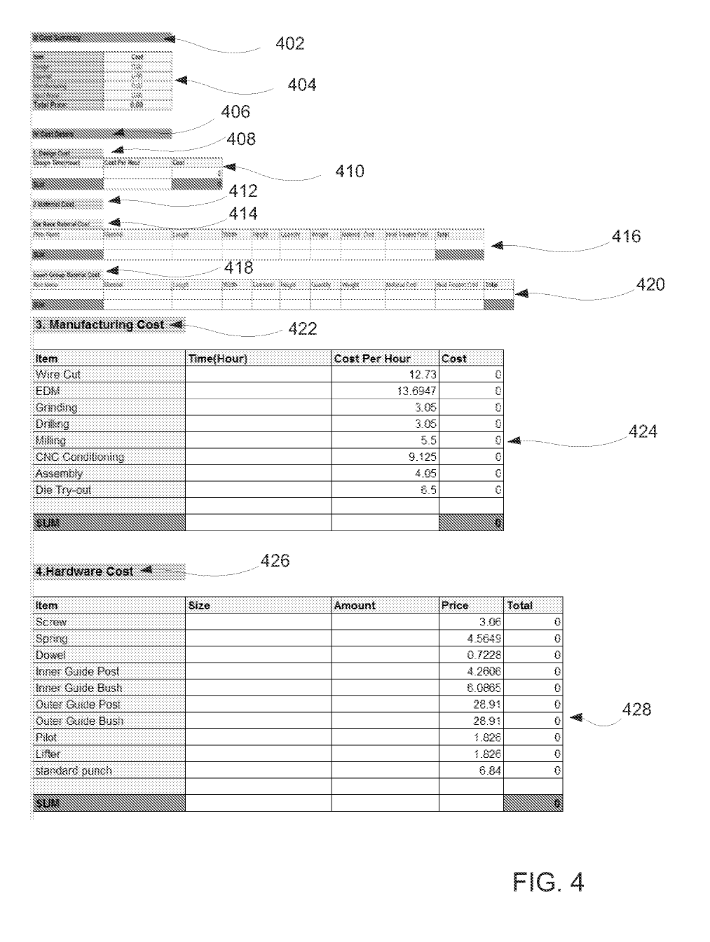

FIG. 4 illustrates an example of a quotation output that could be stored or displayed to a user.

This example shows a cost summary 402 with a cost summary detail 404 broken down into various cost areas.

Cost detail 406 can also be included. For example, a design cost 408 can include the design cost detail 410 including design time and cost for various tasks.

A material cost 412 can be included, and may be broken into a die base material cost 414 (with die base material cost detail 416) and an insert group material cost 418 (with insert group material cost detail 420).

A manufacturing cost 422 can be included, and can include manufacturing cost detail 424.

A hardware cost 426 can be included, and can include hardware cost detail 428.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives, compact disk read only memories (CD-ROMs), or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a product data management (PDM) data processing system, comprising:
receiving a strip layout for a part;
retrieving strip information corresponding to the strip layout;
receiving a die base design for the part;
receiving toolset information for the part;
receiving pricing information corresponding to the toolset information, strip information, and die base design; and
producing a quotation output based on the pricing information, toolset information, strip information, and die base design.

2. The method of claim 1, wherein the PDM data processing system also receives job information for the part, the job information including at least one of a quotation number, a data, a user ID, or a customer ID.

3. The method of claim 1, wherein the strip information includes at least one of a number of rows, a blank size, a number of stations, a pitch distance, a strip width, a strip thickness, a strip material, an amount of sheet metal parts to be produced, or a complex factor.

4. The method of claim 1, wherein the strip information is stored as part attributed in the strip layout.

5. The method of claim 1, wherein the strip information includes a complex factor that indicates the complexity of the part.

6. The method of claim 1, wherein the die base design includes at least one of names of the plates for the die, material for the die, dimensions for the die, and a quantity for the die.

7. The method of claim 1, wherein the PDM data processing system receives insert groups for the die base design, including at least one of piercing inserts, bending inserts, forming inserts, or burring inserts.

8. A product data management (PDM) data processing system comprising:
a processor; and
an accessible Memory, the data processing system particularly configured to receive a strip layout for a part;
retrieve strip information corresponding to the strip layout;
receive a die base design for the part;
receive toolset information for the part;
receive pricing information corresponding to the toolset information, strip information, and die base design; and
produce a quotation output based on the pricing information, toolset information, strip information, and die base design.

9. The data processing system of claim 8, wherein the PDM data processing system also receives job information for the part, the job information including at least one of a quotation number, a data, a user ID, or a customer ID.

10. The data processing system of claim 8, wherein the strip information includes at least one of a number of rows, a blank size, a number of stations, a pitch distance, a strip width, a strip thickness, a strip material, an amount of sheet metal parts to be produced, or a complex factor.

11. The data processing system of claim 8, wherein the strip information is stored as part attributed in the strip layout.

12. The data processing system of claim 8, wherein the strip information includes a complex factor that indicates the complexity of the part.

13. The data processing system of claim 8, wherein the die base design includes at least one of names of the plates for the die, material for the die, dimensions for the die, and a quantity for the die.

14. The data processing system of claim 8, wherein the PDM data processing system receives insert groups for the die base design, including at least one of piercing inserts, bending inserts, forming inserts, or burring inserts.

15. A non-transitory computer-readable medium encoded with executable instructions that, when executed, cause one or more product data management (PDM) data processing systems to:
receive a strip layout for a part;
retrieve strip information corresponding to the strip layout;
receive a die base design for the part;
receive toolset information for the part;
receive pricing information corresponding to the toolset information, strip information, and die base design; and
produce a quotation output based on the pricing information, toolset information, strip information, and die base design.

16. The computer-readable medium of claim 15, wherein the PDM data processing system also receives job information for the part, the job information including at least one of a quotation number, a data, a user ID, or a customer ID.

17. The computer-readable medium of claim 15, wherein the strip information includes at least one of a number of rows, a blank size, a number of stations, a pitch distance, a strip width, a strip thickness, a strip material, an amount of sheet metal parts to be produced, or a complex factor.

18. The computer-readable medium of claim 15, wherein the strip information is stored as part attributed in the strip layout.

19. The computer-readable medium of claim 15, wherein the strip information includes a complex factor that indicates the complexity of the part.

20. The computer-readable medium of claim 15, wherein the die base design includes at least one of names of the plates for the die, material for the die, dimensions for the die, and a quantity for the die.
